(19) United States
(12) Patent Application Publication
(10) Pub. No.: US 2009/0018873 A1
(43) Pub. Date: Jan. 15, 2009

(54) Deferred Premium Annuities

(75) Inventors: Samuel Ramos, Manhasset, NY (US); Scott Silverman, Silver Spring, MD (US); John Fowler, Matawan, NJ (US); Jonathan Hecht, New Rochelle, NY (US); Alexander A. Dubitsky, Larchmont, NY (US); Amar Kuchinad, New York, NY (US); Rebecca Fein, New York, NY (US)

Correspondence Address: LEE & HAYES, PLLC, 601 W. RIVERSIDE AVE., SUITE 1400, SPOKANE, WA, 99201, US

(73) Assignee: Goldman, Sachs & Co., New York, NY (US)

(21) Appl. No.: 12/098,082

(22) Filed: Apr. 4, 2008

Related U.S. Application Data
(60) Provisional application No. 60/910,411, filed on Apr. 5, 2007.

(51) Int. Cl. G06Q 40/00

(52) U.S. Cl. 705/4; 705/37

(57) ABSTRACT

Deferred premium annuities and accompanying methods are described herein. In some instances, a deferred premium annuity allows a purchaser (e.g., an individual) to pledge assets rather than pay cash up front to purchase an annuity. In these instances, an annuity provider then issues an annuity to the purchaser. In some instances, the provider then may then receive ownership of or an interest in the pledged assets upon death of the purchaser unless the purchaser pays for the annuity before the death of the purchaser.

### RELATED APPLICATIONS

This application claims the benefit of U.S. Provisional Application No. 60/910,411 (GS1-0026USP1), filed Apr. 5, 2007, which is incorporated by reference herein.

### BACKGROUND

Traditionally, an individual purchases an annuity contract by paying cash to a life insurance company. This cash then grows on a tax-deferred basis. The life insurance company typically then distributes this money back to the individual throughout the individual's life, and may allow some of the annuity benefits to accrue in the annuity itself. Unfortunately, typical annuity contracts require the individual to provide a lump sum amount of money to the life insurance company at the time of purchasing the annuity contract.

### SUMMARY

Exemplary deferred premium annuities and accompanying methods are described herein. In some instances, an exemplary deferred premium annuity allows a purchaser (e.g., an individual) to pledge assets rather than pay cash upfront to purchase an annuity. In these instances, an annuity provider then issues an annuity to the purchaser. In some instances, the provider then may then receive ownership of or an interest in the pledged assets upon death of the purchaser.

In other instances, the purchaser may substitute the pledged assets with other assets sometime between the initial pledge and the purchaser's death. In these instances, the provider would not receive ownership of or an interest in the initially-pledged assets upon the purchaser's death. Instead, the provider receives ownership of or an interest in the substitute assets upon the purchaser's death.

In still other instances, the purchaser may actually pay cash for the deferred premium annuity at a time after pledging the assets and before the purchaser's death. In these instances, the provider does not receive any ownership or interest in any of the purchaser's assets upon the purchaser's death, as the purchaser has now paid for the annuity.

### BRIEF DESCRIPTION OF THE CONTENTS

The detailed description is described with reference to accompanying figures. In the figures, the left-most digit(s) of a reference number identifies the figure in which the reference number first appears. The use of the same reference numbers in different figures indicates similar or identical items.

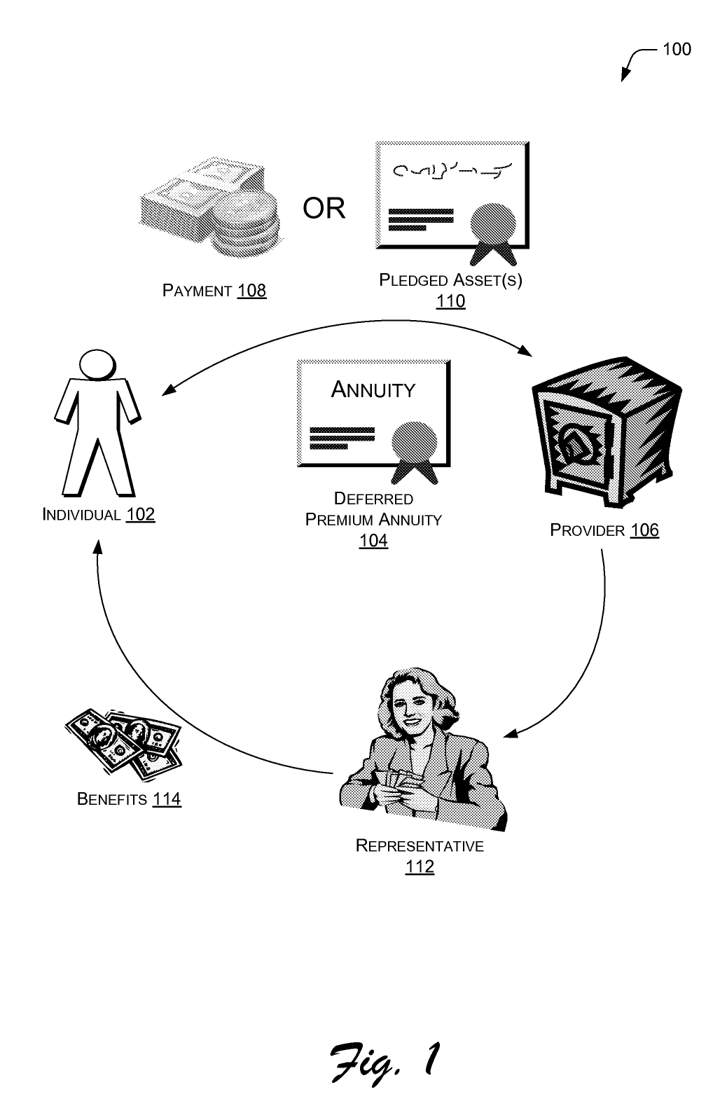

FIG. 1 illustrates an exemplary environment that may utilize the exemplary deferred premium annuities described herein.

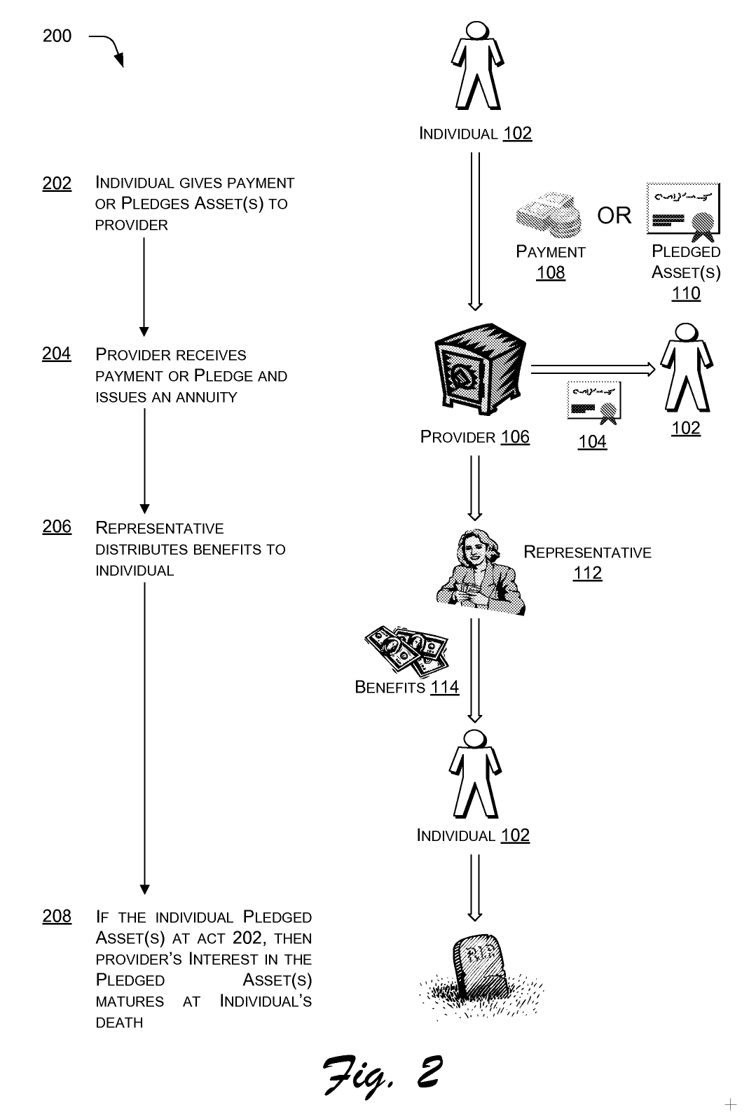

FIG. 2 illustrates an exemplary flow diagram for purchasing an exemplary deferred premium annuity with pledged assets, receiving annuity benefits, and providing any pledged assets to an annuity provider upon death of the annuity holder.

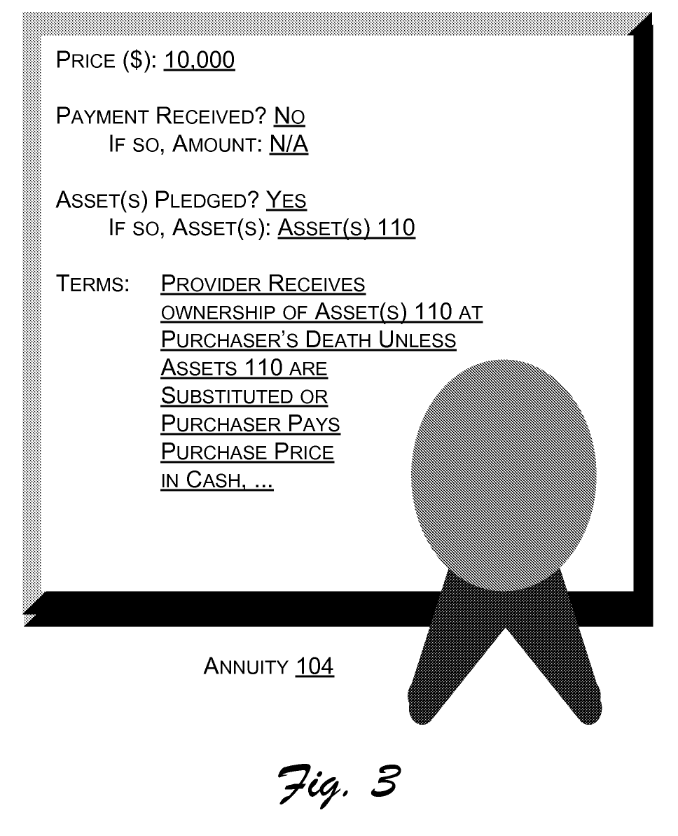

FIG. 3 illustrates exemplary elements of a deferred premium annuity.

### DETAILED DISCUSSION

Overview

This document describes an annuity contract (i.e., “annuity”) that allows an individual or other purchaser to pledge one or more assets to an annuity provider in exchange for a deferred premium annuity. The annuity provider may then sometime in the future receive ownership of or an interest in the pledged assets or in substitute assets, unless the individual pays cash for the annuity some time after the pledge. In some instances, these rights mature at the time of the individual's death. Furthermore, after purchasing the annuity by pledging assets, the individual may receive periodic cash flow from the annuity provider. The individual may also choose at the time of purchase to allow some of these benefits to accrue in the annuity itself. In these latter instances, the annuity provider may distribute these accrued benefits to the individual's beneficiaries upon the individual's death.

Exemplary Environment

FIG. 1 illustrates an exemplary environment 100 that may utilize embodiments of the deferred premium annuities described herein. Environment 100 includes an individual 102 that wishes to purchase an annuity such as deferred premium annuity 104. It is specifically noted that while environment 100 illustrates an individual purchaser, environment 100 may also include other purchasers. It is also noted that while environment 100 and proceeding methods describe annuities, other financial products may also utilize the claimed techniques in some instances.

Returning to FIG. 1, environment 100 also illustrates an annuity provider 106. Annuity provider 106 may be an insurance company or the like that sells annuities to purchasers such as individual 102. Environment 100 may allow individual 102 a choice as to whether to purchase a traditional annuity outright for payment 108, or whether to purchase a deferred premium annuity 104. In the latter instances, individual 102 may choose to pledge one or more assets 110 to secure the annuity. Individual 102 may also provide a portion of payment 108 in addition to pledging one or more assets 110.

Also as illustrated, environment 100 may include a representative 112 of provider 106. In some instances, representative 112 is an individual or entity associated in any way with provider 106. As discussed in detail below with reference to FIG. 2, representative 112 may disperse benefits 114 to individual 102. Again, individual 102 may also choose at the time of purchasing the annuity to allow some benefits 114 to accrue in the individual's deferred premium annuity 104.

Exemplary Method

FIG. 2 illustrates an exemplary process 200, which is illustrated as a collection of blocks in a logical flow graph, which represent a sequence of operations that can be implemented in hardware, software, or a combination thereof. All other processes described throughout may similarly be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

As discussed above, FIG. 2 illustrates process 200 for purchasing a deferred premium annuity 104 and receiving annuity benefits. Process 200 also illustrates annuity provider 106 receiving ownership of or an interest in pledged assets 110 upon death of the annuity holder (e.g., individual 102). Provider 206, however, will not obtain ownership of or an interest in pledged assets 210 if the assets have been substituted with other assets or if the annuity holder pays cash at a time after pledging the assets.

Act 202 illustrates that individual 102 (or other purchaser) may choose whether to purchase a traditional annuity (e.g., a single premium immediate annuity) or a deferred premium annuity 104. Provider 106 may offer this choice in some instances. If individual 102 chooses the former, then individual 102 gives an immediate payment 108 of some consideration (e.g., cash) to annuity provider 106 in exchange for the traditional annuity.

If individual 102 chooses the latter, however, then individual 102 pledges one or more assets 110 to secure deferred premium annuity 104. By so pledging assets 110, individual 102 generally assigns some future rights or interests in the assets to provider 106, which may mature at the individual's death. That is, although individual 102 maintains full ownership and possession of assets 110 during the individual's lifetime, these assets 110 may be used to pay provider 106 for annuity 104 at the time of the individual's death.

In addition, note that in some instances individual 102 may choose to both pledge assets 110 as well as provide annuity provider 106 with some amount of payment 108. In addition, note that if the individual pledges assets 110, then provider 106 may charge a different price for the annuity than if the individual merely purchases the annuity outright with cash. In some instances, for example, provider 106 may charge a higher price for the annuity when individual 102 pledges assets 110.

Pledged assets 110 may comprise any tangible or intangible asset that individual 102 owns or otherwise holds an interest in. Note that in some instances, assets 110 may be a combination of multiple assets. Whatever the pledged assets may be, process 200 allows individual 102 to maintain liquidity by not having to pay a lump sum amount of money at the time of purchase. In addition, this process allows the individual to retain possession of the pledged assets during the individual's life.

Act 204 represents that provider 106 receives either payment 108 or a pledge of assets 110 and, upon reception of the latter, issues deferred premium annuity 104 to individual 102. After issuance, the annuity may provide individual 102 with ongoing benefits 114. Benefits 114 typically include cash flow or the like. As act 206 represents, in some instances representative 112 may distribute some or all of benefits 114 to individual 102. In some instances, individual 102 may elect at the time of purchasing the annuity to allow some of benefits 114 to accrue back into the annuity 104.

Finally, act 208 represents that individual 102 dies sometime after the time at which the individual purchased deferred premium annuity 104. Because individual 102 pledged assets 110 at act 202, act 208 represents that in some instances the provider's ownership of or interest in assets 110 may mature at this time. This ownership of or interest in assets 110 may be used in whole or in part to satisfy payment of annuity 104.

In other instances, however, individual 102 may substitute the initially-pledged assets 110 for one or more other assets between the time of pledging and the time of the individual's death. In these instances, provider 106 may receive ownership of or an interest in the substituted assets at the time of the individual's death.

In other instances, individual 102 may pay cash to provider 106 at a time after the pledging of assets and before the individual's death. In still other instances, beneficiaries of individual 102 may choose to pay cash to provider 106 at or after the time of death of individual 102. In both scenarios, provider 106 would not receive any interest in any pledged assets, as the individual or the individual's beneficiaries would have paid for annuity 104.

Exemplary Deferred Premium Annuity

FIG. 3 illustrates exemplary elements of deferred premium annuity 104. In some instances, information depicted within annuity 104 may be implemented as a data structure encoded on one or more computer-readable media.

Annuity 104 may include many or all of the elements present in a traditional annuity. In addition, deferred premium annuity 104 may include elements unique to a deferred premium annuity issued by exemplary process 200 above. As illustrated, deferred premium annuity 104 states a price (e.g., $10,000), as well as whether payment has been received and/or whether assets have been pledged. In the illustrated embodiment, no payment has been received but the purchaser has pledged assets 110 in exchange for the annuity. As such, the purchaser has assigned future rights in assets 110 to the annuity provider. These rights may mature in the future, unless the purchaser substitutes the assets with other assets or pays for the annuity. In some instances, these future rights may mature at the time of the purchaser's death.

Finally, the annuity lists one or more terms, some or all of which may be unique to deferred premium annuity 104. Other terms, meanwhile, may be common to traditional annuities. In the illustrated embodiment, the terms state that the annuity provider will receive ownership of the pledged assets at the time of the purchaser's death, unless the purchaser substitutes the pledged assets or pays the purchase price of the annuity in cash.

### OTHER EMBODIMENTS

This section describes other embodiments of the tools and techniques described above.

Longevity and Mortality Business—Product Example (Deferred Premium Annuity (“DPA”))

Overview of the Product:
Deferred single premium annuity issued by Commonwealth which may provide insureds with ongoing cash flow (to be spent at their discretion)
The purchase price of the annuity may be fixed at the time of issue, but the insured may have the option to delay payment until death by pledging assets
Annuity may be priced at current market rates, or may be priced higher if annuitant pledges assets
The insured may also choose to let some death benefits accumulate in the annuity as opposed to taking the ongoing cash payments, with this choice being made at the time of purchase.

Strategic Rationale for the Insured
Insureds gain additional liquidity by pledging assets they will not have to part with/liquidate during their lifetime

Marketing/Origination
Marketing/volume origination will be via insurance agents (GA's), financial planners, and estate planners

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
offering an annuity for sale in exchange for a future interest in an asset or for a future interest in an asset and a cash payment;
issuing the annuity to a purchaser in exchange for the purchaser assigning the future interest in the asset or for the purchaser assigning the future interest in the asset and providing the cash payment, wherein the future interest matures upon death of the purchaser;
distributing periodic annuity benefits to the purchaser or accruing the periodic annuity benefits back into the annuity of the purchaser;
if the purchaser or another entity provides full payment for the annuity before or at the death of the purchaser, then relinquishing the future interest in the asset; and
if the purchaser or the another entity does not provide full payment for the annuity before or at the death of the purchaser, then receiving the matured interest in the asset at the death of the purchaser.

2. A method as recited in 1, wherein the purchaser is allowed to retain possession of the asset during the life of the purchaser.

3. A method as recited in 1, wherein the asset comprises tangible property.

4. A method as recited in claim 1, wherein the asset is a first asset, wherein an annuity provider offers the annuity to the purchaser, and further comprising allowing the purchaser of the annuity to substitute a second asset for the first asset, such that the annuity provider receives a future interest in the second asset and relinquishes the future interest in the first asset.

5. A method comprising:
offering an annuity for sale in exchange for a future interest in an asset of a purchaser; and
issuing the annuity to the purchaser in exchange for the purchaser assigning the future interest in the asset, wherein the purchaser is allowed to retain possession of the asset during the lifetime of the purchaser.

6. A method as recited in claim 5, wherein the future interest in the asset matures into a present interest upon death of the purchaser.

7. A method as recited in claim 5, wherein the future interest in the asset matures into a present interest upon death of the purchaser, and further comprising:
upon the death of the purchaser, allowing beneficiaries or an estate of the purchaser to provide cash payment for the annuity; and
if the beneficiaries or the estate of the purchaser provide the cash payment for the annuity, then relinquishing interest in the asset.

8. A method as recited in claim 5, wherein the asset comprises tangible property.

9. A method as recited in claim 5, wherein the asset is a first asset, wherein an annuity provider offers the annuity to the purchaser, and further comprising allowing the purchaser of the annuity to substitute a second asset for the first asset, such that the annuity provider receives a future interest in the second asset and relinquishes the future interest in the first asset.

10. A method as recited in claim 5, further comprising:
receiving a cash payment in an amount equal to a stated purchase price of the annuity; and
relinquishing the future interest in the asset in response to the receiving of the cash payment.

11. A method as recited in claim 5, further comprising:
offering the annuity for sale in exchange for cash payment; and
offering the annuity for sale in exchange for a combination of cash payment and a future interest in an asset of the purchaser.

12. A method as recited in claim 5, further comprising:
offering the annuity for sale in exchange for cash payment; and
offering the annuity for sale in exchange for a combination of cash payment and a future interest in an asset of the purchaser;
wherein a purchase price of the annuity for sale varies based at least in part on whether the purchaser exchanges a future interest in an asset, a cash payment, or a combination thereof for the annuity.

13. One or more computer-readable media storing computer-executable instructions that, when executed on one or more processors, perform acts comprising:
receiving a future interest in an asset of a purchaser, wherein the future interest matures upon death of the purchaser; and
issuing an annuity to the purchaser in response to the receiving of the future interest in the asset.

14. One or more computer-readable media as recited in claim 13, wherein the purchaser is allowed to retain possession of the asset during the lifetime of the purchaser.

15. One or more computer-readable media as recited in claim 13, wherein the asset comprises tangible property.

16. One or more computer-readable media as recited in claim 13, wherein the asset is a first asset, and further comprising:
receiving a future interest in a second asset of the purchaser; and
relinquishing the future interest in the first asset of the purchaser in response to the receiving of the future interest in the second asset.

17. One or more computer-readable media as recited in claim 13, further comprising:
receiving an indication that the purchaser or another entity has provided a cash payment for some or all of a purchase price of the annuity; and
relinquishing some or all of the future interest in the asset of the purchaser in response to the receiving of the cash payment.

18. One or more computer-readable media as recited in claim 13, further comprising:
offering the annuity for sale in exchange for a future interest in an asset of a purchaser;
offering the annuity for sale in exchange for cash payment; and
offering the annuity for sale in exchange for a combination of cash payment and a future interest in an asset of a purchaser.

19. One or more computer-readable media as recited in claim 13, further comprising:
offering the annuity for sale in exchange for a future interest in an asset of a purchaser;
offering the annuity for sale in exchange for cash payment; and
offering the annuity for sale in exchange for a combination of cash payment and a future interest in an asset of a purchaser;
wherein a price of the annuity for sale varies based at least in part on whether the purchaser exchanges a future interest in an asset, a cash payment, or a combination thereof for the annuity.

20. One or more computing devices, comprising:
one or more processors; and
the one or more computer-readable media storing the computer-executable instructions as recited in claim 13.
